(19) United States
(12) Patent Application Publication
(10) Pub. No.: US 2010/0318387 A1
(43) Pub. Date: Dec. 16, 2010

(54) SYSTEMS AND METHODS FOR THE ELECTRONIC DISTRIBUTION OF TRIP RELATED INFORMATION

(76) Inventors: Kanjilal Kishore, Mumbai (IN); Narayan Ravi, Mumbai (IN); Verma Anuj, Mumbai (IN); Tharail Vinod, Mumbai (IN); Karat Vinay, Mumbai (IN); Chavan Sagar, Mumbai (IN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/866,211

(22) PCT Filed: Oct. 21, 2008
(86) PCT No.: PCT/IN08/00692

§ 371 Date: Aug. 4, 2010

(30) Foreign Application Priority Data
Feb. 5, 2008 (IN) 250/MUM/2008

(51) Int. Cl. G06Q 50/00; G06Q 10/00; G06F 15/16

(52) U.S. Cl. 705/5; 709/217

(57) ABSTRACT

Methods for distributing trip related information on board passenger carrier are presented. In some embodiments, a method for distributing passenger trip related information includes storing and updating passenger information, seat information, vehicle timing information, and/or any other travel information in a Departure Control System. Changes to the stored information may be forwarded to a Passenger Information Delivery and Display System Server through a communication network. In some embodiments, a Passenger Information Delivery and Displayer client system may utilize a computer-implemented method for collecting, retrieving, and displaying the information stored the Departure Control System.

### FIELD OF THE INVENTION

The present invention relates to dynamic and real-time information delivery and, in particular, to methods for providing dynamic and real-time information for monitoring and displaying trip related information onboard passenger carriers.

### DESCRIPTION OF RELATED ART

Trip information including travel, vehicle, and passenger information is currently provided on board commercial carriers in a printed form. Travel information can include duration, entertainment options, stopovers, layover time, meal service and times, cabin staff schedules, etc; vehicle information can include seating configurations, occupied and unoccupied seats, cabins, zones, classes of services, etc; and/or passenger information including seat-specific passenger occupancy information, passenger profile information, specific passenger requests, passenger meal preferences, one or more indicators assigned to individual passengers indicative of any special treatment that should be afforded to such passengers, infant information, and seat occupancy information for individual seats, rows, classes, and/or zones may not be included in printed travel information. The use of printed forms can cause problems related to the timely delivery of printed information, distribution of printed information to the crew and other interested parties, and increase the likelihood for loss and/or damage to the information. For example, printed information may be torn, soiled, damaged, and/or rendered unusable. Further, printed information is often incomplete and cannot be easily updated to reflect the latest up-to-the-minute information. Problems inherent with printed travel information can lead to difficulties in handling emergencies, an inability to respond to special requirements of passengers, impediments to priority service of special passengers, outdated information, loss of information, and/or unavailability of information at a specific location and time.

Moreover, the distribution of trip information to commercial carrier crews and other interested parties often requires the use of complex, cumbersome, unreliable, and error prone distribution procedures. In addition, the amount and/or scope of included trip information may be limited due to area constraints related to the size and volume of the printed pages. Thus, there is a need for methods that automate the delivery and presentation of dynamic and real-time passenger, passenger services, vehicle and travel information to commercial carrier crews and other interested parties in order to reduce passenger service time, improve the quality of service provided to passengers, and facilitate the introduction of future services.

### SUMMARY

In accordance some embodiments, methods for distributing trip information are presented. In some embodiments, a method for distributing trip information to a commercial carrier vehicle, wherein the trip information includes at least one of passenger, travel, and vehicle information, may comprise electronically compiling the trip information; processing the trip information; electronically distributing the trip information to a computing device located on-board the commercial carrier, in response to a triggering event; and displaying the trip information. Embodiments of the present invention also relate to software, firmware, and program instructions created, stored, accessed, or modified by processors using computer-readable media or computer-readable memory. The methods described may be performed on a computer and/or a printing device.

These and other embodiments are further explained below with respect to the following figures.

### BRIEF DESCRIPTION OF THE DRAWINGS

FIG. 1 shows a functional block diagram illustrating the components of an exemplary system.

FIG. 2 shows a block diagram illustrating an exemplary system including a Passenger Information Delivery and Display System (“PIDDS”) server, a PIDDS client, a clock, and a Departure Control System (“DCS”).

FIG. 3 shows a block diagram illustrating an exemplary system including a PIDDS client, monitor, user interface, and a PIDDS server.

FIG. 4 shows a flow diagram illustrating a process of downloading information from a DCS to a PIDDS server.

FIG. 5 shows an exemplary flow diagram illustrating a process of downloading information from a DCS to a PIDDS client.

FIG. 6 shows an exemplary flow diagram illustrating a process of actuating a PIDDS client to display screens on a user monitor.

FIG. 7 shows a screen display illustrating an exemplary embodiment of a Summary Report Screen.

FIG. 8 shows a screen display illustrating an exemplary embodiment of a Meals Report Screen.

FIG. 9 shows a screen display illustrating an exemplary embodiment of a Passenger Information Report Screen.

FIG. 10 shows a screen display illustrating an exemplary embodiment of a Special Services Request (“SSR”) Report Screen.

FIG. 11 shows a screen display illustrating an exemplary embodiment of an Onward Connection Report Screen.

### DESCRIPTION OF THE EMBODIMENTS

Reference will now be made in detail to one or more exemplary embodiments of the present invention as illustrated in the accompanying drawings. Wherever possible, the same reference numbers will be used throughout the drawings to refer to the same or like parts.

Embodiments of present invention may provide for the distribution of dynamic and/or real-time trip information. In some embodiments, dynamic and/or real-time information may be provided to vehicle crew and other interested parties in electronic form via a data processing system using a display monitor, or any other fixed or mobile humanly perceivable system on board a vehicle. This may allow for timely and streamlined delivery of information to the crew and other interested parties, and a reduction in costs and losses associated with the distribution of printed information. Further, electronically distributed trip information may be dynamically updated to reflect any up-to-the minute changes in the trip information. This method of distribution may lead to, for example, more efficient service, ease in handling emergencies, an increased ability response to special requirements of passengers, improved facilitation of priority service of special passengers, the timely availability of travel information, easier retrieval of information, the ability to dynamically update information to reflect up-to-the minute changes, and/or easier and more efficient distribution of error-free trip information. In addition, electronically distributed trip information can be interactive and/or tailored to user requirements obviating size, volume, and detail restrictions associated with printed trip information.

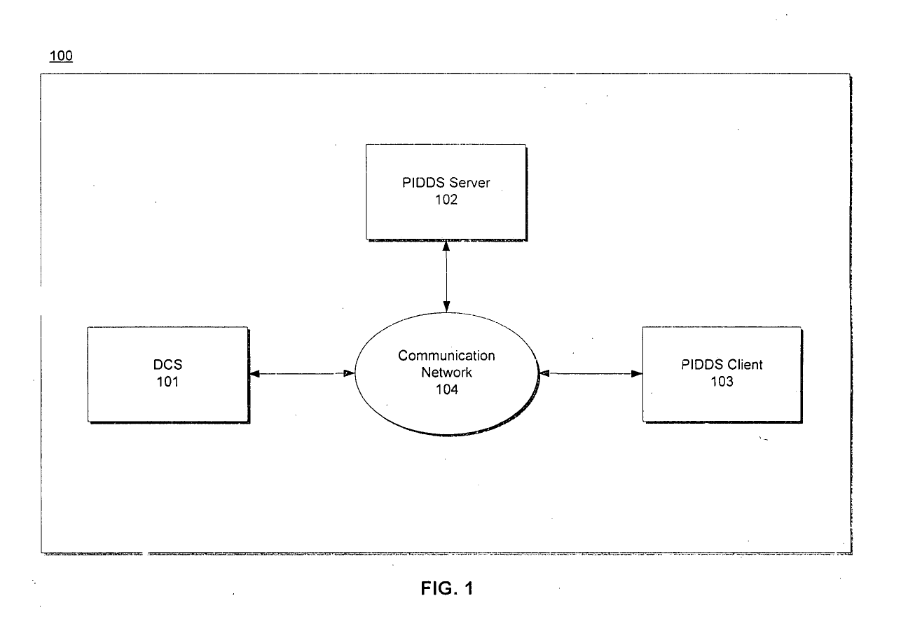

In some embodiments, a method may include electronically compiling, processing, and providing up-to-date information related to passengers, a specific trip and/or vehicle information to crew and other interested parties on board a commercial carrier vehicle. FIG. 1 shows a functional block diagram illustrating the components of an exemplary system 100 in accordance with some embodiments. As illustrated, exemplary system 100 may comprise Departure Control System (“DCS”) 101, Passenger Information Delivery and Display System Server (“PIDDS server”) 102, Passenger Information Delivery and Display System Client (“PIDDS client”) 103, and Communication Network 104.

In some embodiments, DCS 101 may include one or more databases. DCS 101 may include a database containing trip information records, including travel, vehicle, and passenger information. For example, DCS 101 may include a trip information database, and any other related information that may be maintained, updated, and downloaded to PIDDS server 102. Exemplary system 100 may operate via query and response, wherein updated information on passengers accepted on a vehicle is provided to PIDDS server 102 in response to a user query. In some embodiments, upon completion of the passenger acceptance process, final updated information may be sent by DCS 101 to PIDDS server 102.

PIDDS server 102 may include a transaction service system and a data repository of information retrieved from DCS 101. In some embodiments, information retrieved from DCS 101 may include trip information. In some embodiments, PIDDS client 103 may obtain real-time passenger information through PIDDS server 102.

PIDDS client 103 may include a data repository and implement one or more computer programs that provide a display interface, such as a passenger dashboard display to the crew and other interested parties with summary and/or detailed information on passenger information, meal information, Special Service Request (“SSR”) information, and onward connection information. SSRs can be made by passengers, and in some instances may be based on a list of permitted Special Services as approved by the International Air Transport Association (“IATA”) or any other appropriate transport authority, carrier line, or carrier. In some embodiments, the data repository of PIDDS client 103 may be updated with data sent by the PIDDS server 102.

PIDDS server 102 may include a data system that communicates with the PIDDS client 103 and DCS 101 to retrieve information from DCS 101 and enable PIDDS client 103 to display information. In some embodiments, PIDDS client 103 may include a data processing system on board the vehicle, to process and display travel information using monitors and/or other display devices. Communication Network 104 may be connected to the DCS 101, PIDDS client 103, and PIDDS server 102 to facilitate the exchange of information between the systems.

Communication Network 104 may implement a network communications system. In some embodiments, Communication Network 104 may include, for example a Local Area Network, a Wide Area Network, a Wireless Network, and/or the Internet. Further, Communication Network 104 may be configured to allow DCS 101, PIDDS server 102, and PIDDS client 103 to communicate with each other.

Changes to passenger information, seat information, vehicle timing information, or any other trip information may be reflected in DCS 101, which may forward the updated details to PIDDS server 102 using Communications Network 104. In some embodiments, the changes may be forwarded to PIDDS server 102 at the time DCS records are updated. In some embodiments, PIDDS client 103 may utilize a computer-implemented method for collecting, retrieving, and displaying vehicle seat specific passenger occupancy information individually or collectively. In some embodiments, the collection, retrieval, and display of trip information may include continuously transmitting and updating such information from a host system to a processing system and displaying the updated information on a display system coupled to the processing system. In some embodiments, the information may be updated and transmitted periodically and the display refreshed accordingly. In some embodiments, the information may be updated and transmitted on demand and the display refreshed accordingly.

Changes to flight, aircraft, passenger, and/or other trip information may be stored in DCS 101. In some embodiments, DCS 101 forwards information to PIDDS server 102. For example, DCS 101 may transfer information to PIDDS server 102 by scheduled transactions or in response to specific requests from PIDDS server 102 using Communication Network 104. Similarly, PIDDS client 103 either periodically, or in response to a user request, may download information from PIDDS server 102 via Communication Network 104. In some embodiments, PIDDS client 103 may download information from PIDDS server 102 until the passenger acceptance process is complete, at which time PIDDS client 103 may receive finalized passenger information from PIDDS server 102.

Embodiments may be implemented and practiced by an air travel carrier. In such embodiments, a vehicle may be an aircraft and a trip may be a specific flight conducted by a commercial airline carrier. At some point during the passenger acceptance process a program implementing PIDDS methods may be started on PIDDS client 103. A vehicle trip number, which in some embodiments includes an airline flight code number and a date, may be provided to the system as an input. PIDDS client 103 may receive passenger travel information, seat information, vehicle timing information, and/or other trip information from PIDDS server 102. PIDDS server 102 in turn may receive trip information from DCS 101. After the information is received by PIDDS client 103, a first screen of the display interface may be displayed on a monitor attached to the PIDDS client system.

In some embodiments, passenger travel information may be downloaded by the vehicle crew and other interested parties from the trip and passenger acceptance control system as soon as the passenger acceptance process for a specific journey of a vehicle commences. The downloaded information may be updated dynamically periodically or in real-time as required, and finalized information may be downloaded upon completion of the passenger acceptance process for a specific vehicle trip.

Travel information may include passenger information for the vehicle. In some embodiments, passenger information may include the number of passengers booked for the trip (booked load), the number of passengers accepted for the trip (actual load), passenger profile information, passenger requests, passenger meal preference information, passenger value information, infant information, seat occupancy information, onward connection information, and any other passenger travel information. Seat information may provide information on type and location of each seat in the vehicle. The seat information may be available for type of each seat, window, aisle or middle of the vehicle and may describe the nature of seat depending on the cabin the seat is located in. Seat information may be retrieved for the entire vehicle, cabin wise, zone wise, row wise or for an individual seat. Vehicle timing information may include a scheduled departure time of the vehicle for a trip and a scheduled arrival time for the trip. In some embodiments, vehicle timing information may further include an estimated departure time and an estimated arrival time.

Vehicle crew and other interested parties may view travel information via a display that may include a plurality of screens. In some embodiments, the displayed screens may include a Summary Report Screen, a Meals View Screen, a Passenger View Screen, a SSR View Screen, and an Onward Connection View Screen as described below.

Embodiments may also be implemented in a stand-alone or in a distributed computing environment. In a distributed computing environment, program modules may be physically located in different local and remote memory storage devices. Execution of the program modules may occur locally in a stand-alone manner or remotely in a client/server manner. Examples of such distributed computing environments may include local area networks of an office, enterprise-wide computer networks, and the global Internet.

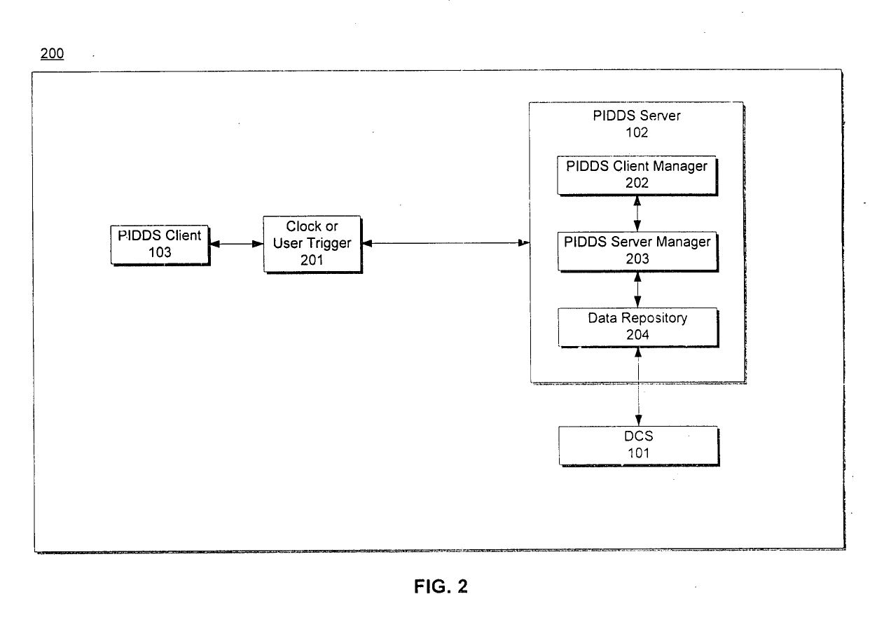

FIG. 2 shows a functional block diagram illustrating an exemplary system 200, which may include PIDDS server 102, PIDDS client 103, clock or user trigger 201 and DCS 101. As illustrated, PIDDS server 102 may include data repository 204, PIDDS server manager 203, and PIDDS client manager 202.

In some embodiments, data repository 204 may contain updated trip information downloaded from DCS 101. In some embodiments, trip information may be downloaded by PIDDS server 102 using a program interface. PIDDS server manager 202 may include programs for providing the transaction interface to DCS 101 and for scheduling and executing transactions using a display interface to receive updated trip information from DCS 101. Further PIDDS server manager 202 may include programs for updating data repository 204.

The transactions between PIDDS server 102 and DCS 101 may be triggered by a clock or a user 201 or by PIDDS client 103. In some embodiments, user may set triggers based on logical or actual events. For example, closure of passenger acceptance to the vehicle, a set time prior to departure, and/or closing of an aircraft door may be used to trigger transactions. In some embodiments, PIDDS client manager 202 may authenticate PIDDS client 103 through accessing the server and may control access permissions based on the access procedure of PIDDS client 103 accessing the PIDDS server 102.

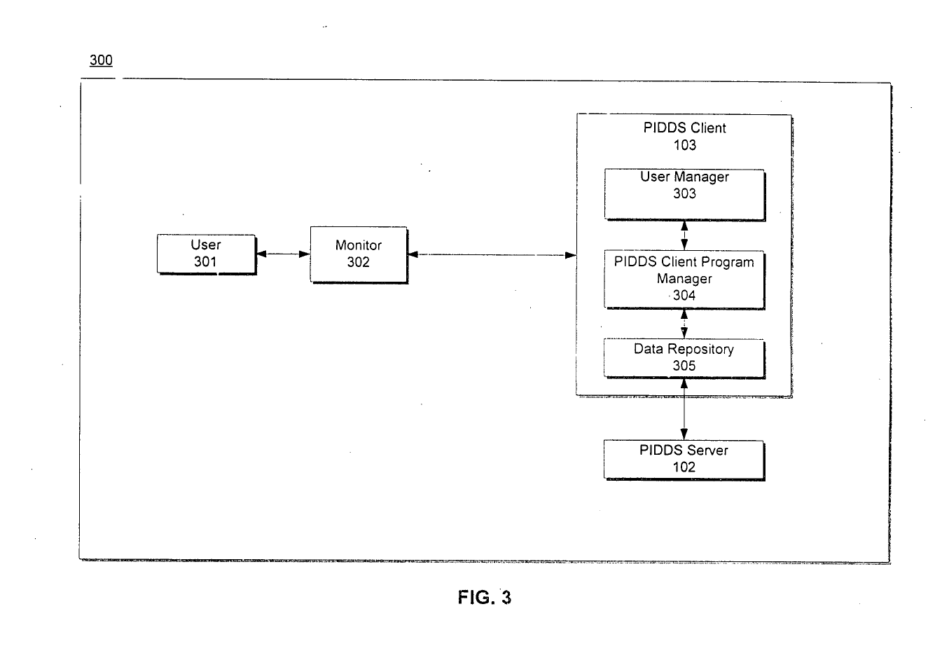

FIG. 3 is a block diagram illustrating an exemplary system 300, which may include PIDDS client 103, Monitor 302, User 301 and PIDDS server 102. As illustrated, PIDDS client 103 may include data repository 305, PIDDS Client Program Manager 304 and User manager 304.

In some embodiments, data repository 305 may contain trip information, which may be downloaded from PIDDS server 102 using a program interface, master tables, user tables, rule based access rights tables, and/or screen definitions. PIDDS Client Program Manager 304 may include programs for providing a program interface to PIDDS server 102 and for receiving updated trip information from PIDDS server 102. Further. PIDDS Client Program Manager 304 may also include programs for managing data repository 305.

In some embodiments, the program interface may be triggered by a user 301 using a monitor 302 (i.e. display). PIDDS Client Program Manager 304 may be actuated by the user 301 using monitor 302 to display various screens. For example, monitor 302 may display a Summary screen showing high-level trip information. Further, monitor 302 may display various detail screens that include passenger information, meal information, SSR information, onward connection information, and/or any other travel information. In some embodiments, User Manager 303 may be utilized to authenticate user 301 that attempts to access PIDDS client 103 using monitor 302 and access permission procedures associated with user 301 accessing PIDDS client 103.

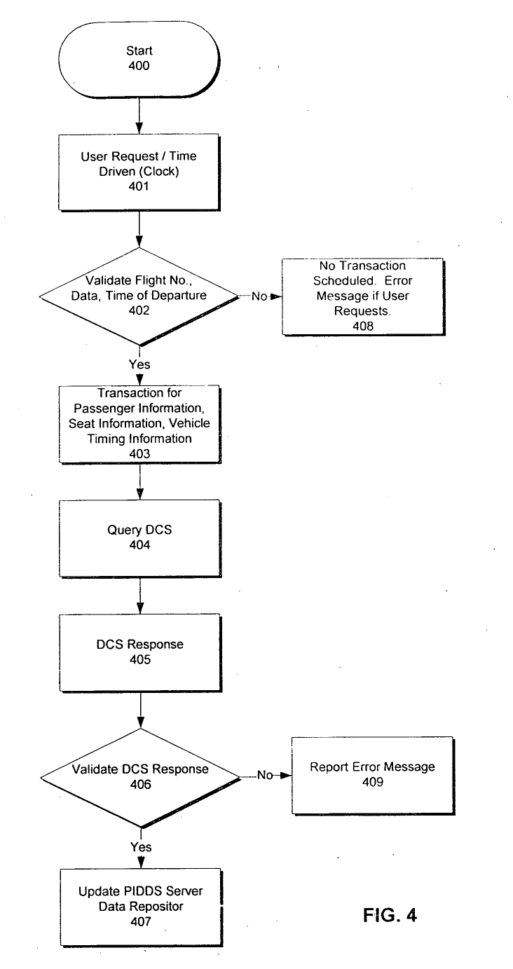

FIG. 4 shows a flow diagram 400 illustrating an exemplary process of downloading information from a DCS 101 to a PIDDS server 102. After initializing, the process may begin at step 401 and request information from DCS 101. In some embodiments, the information may be requested by PIDDS server 102. In some embodiments, this request may be initiated by a trigger, which may be time driven, pre-set by the user based on various criteria, and/or a real time user request.

In some embodiments, at step 402, the request for download may be validated. Requests can be made by users, and can also be triggered based on a clock, or based on one or more predefined automated criteria. For example, request validation may check if a valid flight number, date, and/or time have been entered by a user. If the request is found to be valid, step 403 may be executed wherein the request is parsed and converted into a specific format to send a query for trip information to DCS 101. In some embodiments, if the validation at step 402 fails, the source of the request may be identified at step 408. In one embodiment, if the request was triggered by a period clock signal, or based on other automated criteria, no query may be made to DCS 101, the error may be logged, and the process terminates However if the request was made by a user, the error may be logged, and the user may be informed about the error. In some instances, the user may be informed by sending the error message to the device where the query originated.

After parsing and converting the request at step 403, DCS 101 may be sent a corresponding query for information at step 404. In some embodiments, upon receipt of the query by DCS 101, step 405 may be executed wherein a response to the query may be received and/or parsed by the PIDDS server 102 at the DCS 101. The received response may be validated at step 406. If no errors are detected, the PIDDS server data repository 204 may be updated from the response received from DCS 101 at step 407 and the process may terminate. If errors are detected in the received response from DCS 101, an error report message may be generated at step 409.

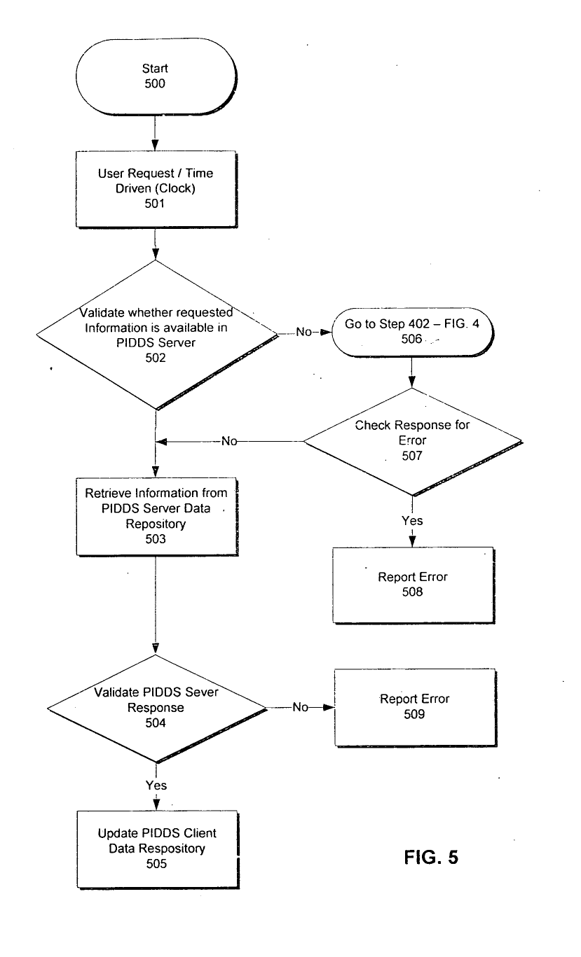

FIG. 5 shows an exemplary flow diagram illustrating an exemplary process of downloading information from a DCS 101 to a PIDDS client 103. After initialization at step 500, the process continues at step 501 with a request from the PIDDS client 103 for trip information. In some embodiments, the request may be sent to PIDDS server 102. In some embodiments, this request may be initiated by a trigger, which may be generated by a time driven clock signal or a user request.

In some embodiments, at step 402, the request for download may be validated to check whether the requested information is available in PIDDS server 102 for a requested trip. If the requested data is available, the data may be retrieved from PIDDS server 102 and sent to the PIDDS client 103 at step 503. If the requested data is not available, the process may proceed to step 402 of FIG. 4 at step 502. A check may be performed to determine if any errors are returned by steps 408 or 409 in FIG. 4 at step 507. If no errors are detected, the process may proceed to step 503. If errors are detected, however, the error may be reported at step 508 and the process may be terminated.

At step 503, the requested information is retrieved by PIDDS client 103 from the PIDDS server data repository 204. In some embodiments, the retrieved information may be parsed and validated at step 504. If errors are found, an error report may be generated at step 509 and the process may proceed to terminate. However, if there are no errors, the PIDDS client data repository 305 may be updated accordingly at step 505 based on the retrieved information.

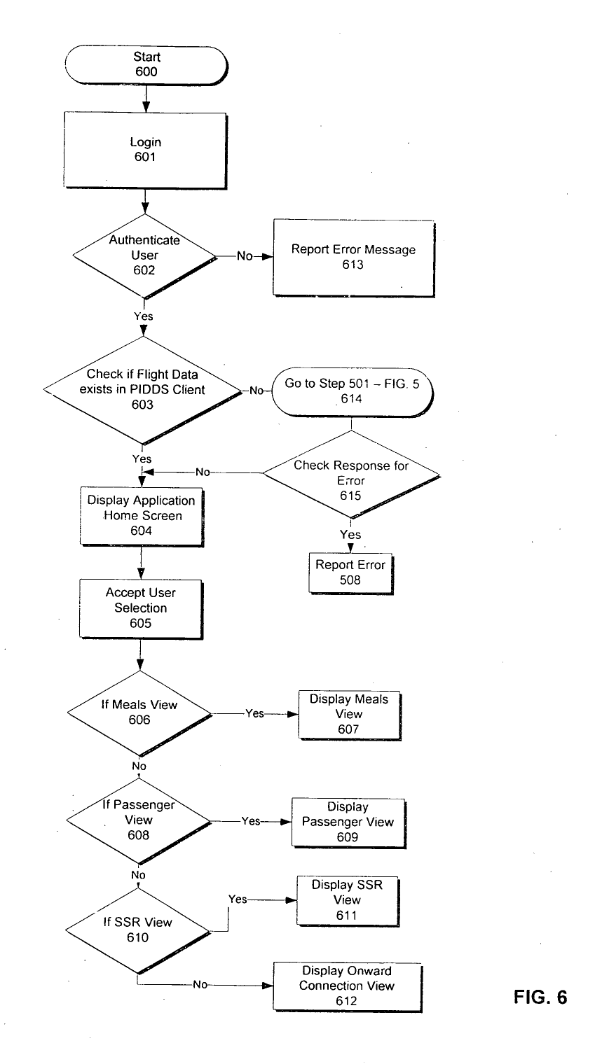

FIG. 6 shows an exemplary flow diagram illustrating an exemplary process of actuating a PIDDS client 103 to display screens on a user monitor. After initiating 600, the process may begin at step 601 by a user logging into the system using login credentials. In some embodiments, login credentials may include a user ID, password, flight number, and/or date. At step 602, the PIDDS client 102 may authenticate the user based on the user credentials provided at step 602. If the credentials provided are found to be invalid, the process may terminate and an error message may be reported at step 613. If the credentials provided are authenticated, the PIDDS client 103 checks to see if information regarding the requested flight number and/or date is available in the PIDDS client 103 at step 603.

In some embodiments, if information regarding the requested flight number and/or data is not available in PIDDS client 103, the process may proceed to step 501 of FIG. 5 at step 614. If the requested information is available, the process may proceed to step 604. A check may be performed to determine if any errors are returned by steps 508 or 509 in FIG. 5 at step 615. If no errors are detected, the process may proceed to step 604. If errors are detected, however, the error may be reported at step 508 and the process may be terminated.

At step 604, an application homepage may be displayed on a monitor by PIDDS client 103. In some embodiments, the monitor may be integrated into PIDDS client 103. The displayed application homepage may include a high level summary of the travel information for the requested flight and/or date. Further, the homepage may include links to pages/screens that include detailed travel information. For example, the homepage may include links to a detailed Meals View screen, Passenger View screen, SSR View screen, and Onward Connection View screen. In some embodiments, at step 605, a user request for displaying detailed travel information may be received by PIDDS client 103.

For example, Passenger Profile information, Passenger Request information, Passenger Meal Preference information, Passenger Value information, Passenger Travel information, Infant information, and/or any other Passenger information may be collected, retrieved, and displayed individually or collectively for the seats of a commercial carrier vehicle. Further, seat occupancy information for individual seats, rows (i.e. row-wise), service classes (i.e. class-wise), and/or zones (i.e. zone-wise) may be retrieved for vehicle crew and other interested parties on or off board a vehicle.

In some embodiments travel information may be continuously transmitted and updated from a host system to a processor system that provides the travel information to a display monitor or other humanly perceivable system coupled to the processing system on or off board a vehicle. The display may provide for an initial screen, which may include general vehicle seat layout information, prior to displaying passenger-specific information. Passenger-specific seat assignment information and associated passenger information may then be displayed to vehicle crew and other interested parties. Passenger-specific information may be continuously received and updated from a host data system by the processor system, which may in turn update the displayed travel information.

At the closure of passenger acceptance to the vehicle, final and complete travel information that can include passenger-specific information may be received and updated by the processor system. In some embodiments, this may include continuously receiving and updating the passenger-specific information from a host data system to a processing system and providing information on a display monitor or other humanly perceivable system coupled to the processing system automatically or in response to a signal from the crew or other interested parties.

Information provided by the processor system to the display may be updated in real-time. Accordingly, up-to-the minute travel information may be provided to vehicle crew and other interested parties. Trip information may include passenger specific travel information, which may include, for example, passenger information, travel information and vehicle timing information. In some embodiments, passenger travel information may be made available on a display monitor or other humanly perceivable system through a data storage and retrieval system provided by a program on board the stationary or moving vehicle to the crew and other interested parties. Thus, relevant information may be quickly retrieved by vehicle crew and other interested parties on a stationary or moving vehicle.

At step 606, PIDDS client 103 may check if the user has requested to view a detailed Meals View screen. If the user has requested a detailed Meals View screen, a Meals View screen may be displayed at step 607. Otherwise, the process may proceed to step 608. At step 608, PIDDS client 103 may check if the user has requested to view a detailed Passenger View screen. If the user has requested a detailed Passenger View screen, a Passenger View screen may be displayed at step 609. Otherwise, the process may proceed to step 610. At step 610, PIDDS client 103 may check if the user has requested to view a detailed SSR View screen. If the user has requested a detailed SSR View screen, a SSR View screen may be displayed at step 611. Otherwise, an Onward Connection View screen may be displayed.

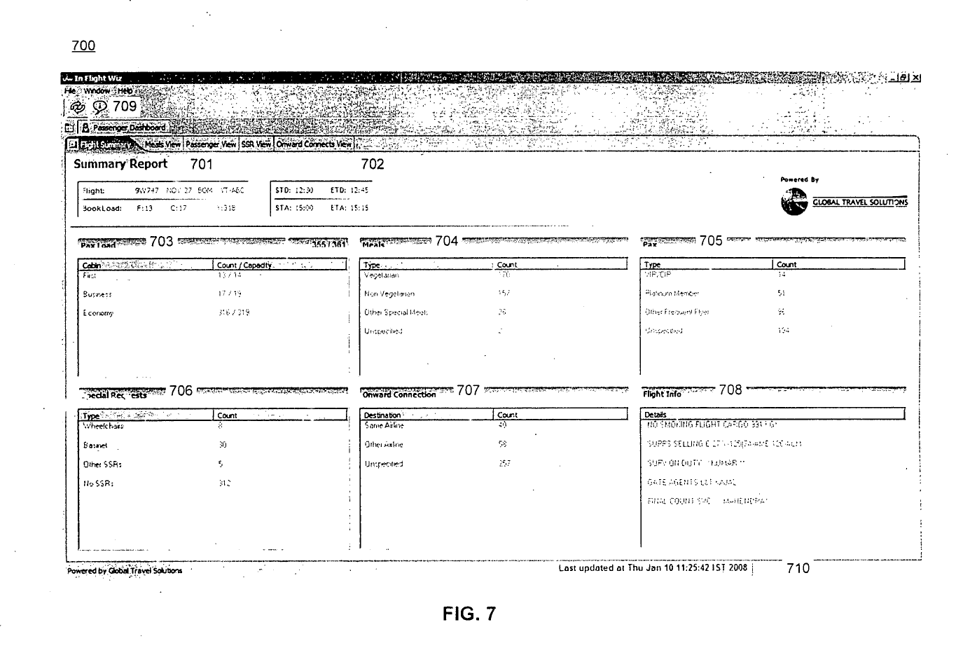

FIG. 7 shows a screen display illustrating an exemplary embodiment of the Summary Report Screen 700. As illustrated, Summary Report Screen 700 may include the flight number, flight date, aircraft type and booked load 701. Further, flight timing information may be given in 702. In some embodiments Summary Report Screen 700 may be divided into six boxes that provide the total count of passengers accepted in each class 703, the total meal count and count of each meal type 704, the total seat count and count of each passenger type 705, the total special requests and count for types of special requests 706, onward connection information of passengers with the same airline's flight or a different airline's flight 707, and flight information providing static information of a flight characteristics and the personnel required to handle the flight 708. In some embodiments, one or more screens displayed by the Passenger Dashboard interface may include a Refresh button 709 to initiate a download of updated information from the PIDDS server 102 when passenger acceptance is in progress and to initiate a download of finalized updated information to 103 PIDDS client when the passenger acceptance process is complete. In some embodiments, after the final download is completed, PIDDS client 103 may contain the complete data for the flight. Further, a time-stamp of the last information update may be displayed at the bottom of the screen as shown in 710.

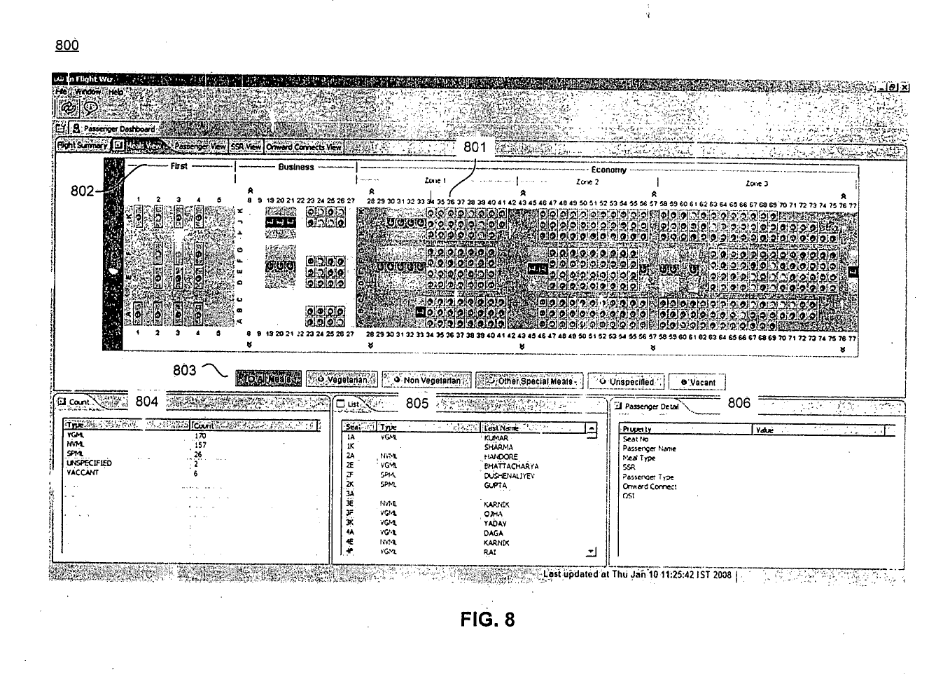

FIG. 8 shows a screen display illustrating an exemplary embodiment of the Meals View Screen 800. As illustrated, Meals View Screen 800 may include a display of the seat map 801 of the aircraft bearing seat numbers with demarcations for each class and zones within each class and may include specific meal type encoded for each seat. In some embodiments, seat map 801 may be selected according to the seating configuration of the aircraft for the trip. Further, in some embodiments, the type of meals to be served may be color coded and be reflected on each seat. A user may change the display seat map 801 using clickable buttons 802. In some embodiments, a user may use clickable buttons to display a seat map 801 for an entire aircraft, a particular seating class (i.e. class-wise), a particular zone (i.e. zone-wise), and/or a particular row (i.e. row-wise). In some embodiments, if a particular type of meal is selected 803, only the selected meal type may be displayed on the seats.

In some embodiments, Meals View Screen 800 may be divided into a plurality of boxes. For example, a first box 804 may display the counts of the meal types associated with the seats displayed in seat map 801. A second box 805 may display the seat number, passenger names, and meal type based on the type of meal selected 803 associated with the seats displayed in seat map 801. In some embodiments, each seat in seat map 801 may be clickable or selected from a displayed seating list. Upon clicking or selecting a particular seat, detailed passenger information may be displayed in a third box 806.

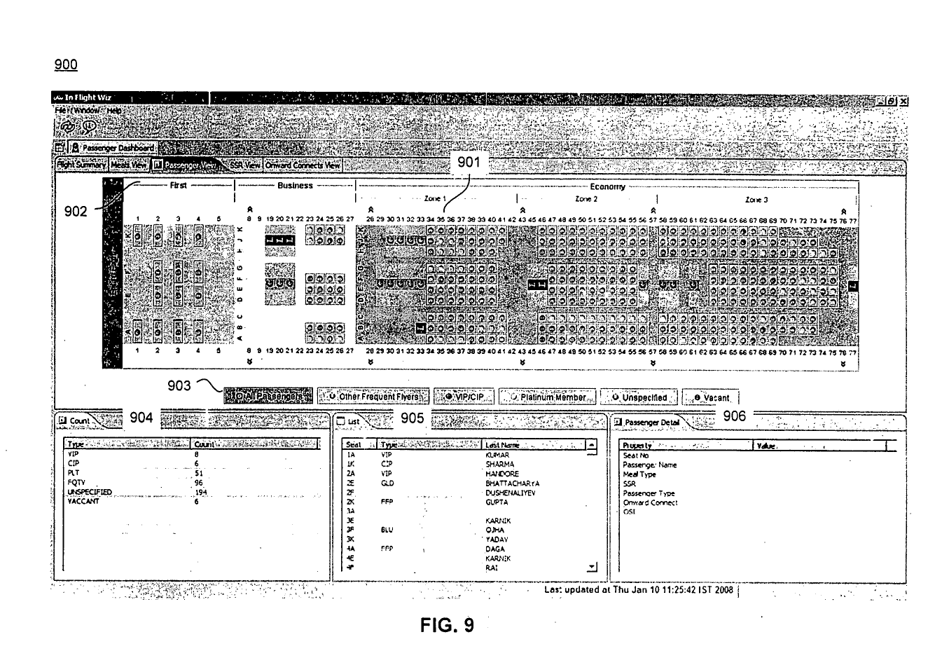

FIG. 9 shows a screen display illustrating an exemplary embodiment of a Passenger View Screen 900. As illustrated, Passenger View Screen 900 may include seat map 901. In some embodiments, seat map 901 may include seat numbers with demarcations for each class and zones within each class and may include encodings for specific passenger type. In some embodiments, seat map 901 may be selected according to the seating configuration of the aircraft for the trip. Further, in some embodiments, the type of passenger occupying the seats may be color coded and may be reflected on each seat. A user may change the display seat map 901 using clickable buttons 903. In some embodiments, a user may use clickable buttons to display a seat map 901 for an entire aircraft, a particular seating class (i.e. class-wise), a particular zone (i.e. zone-wise), and/or a particular row (i.e. row-wise). In some embodiments, if a particular passenger type is selected 902, only the selected passenger type may be displayed on the seats.

In some embodiments, Passenger View Screen may be divided into a plurality of parts. For example, a first part 904 may display counts of the passenger types of the portion of the seat map 901 displayed. A second part 905 may list the seat number, passenger names and/or passenger type which may be based on the type of passenger and portion of the seat map selected. In some embodiments, each seat in seat map 901 may be clickable or selected from a displayed seating list. Upon clicking or selecting a particular seat, detailed passenger information of the passenger occupying the seat may be displayed in a third part 906.

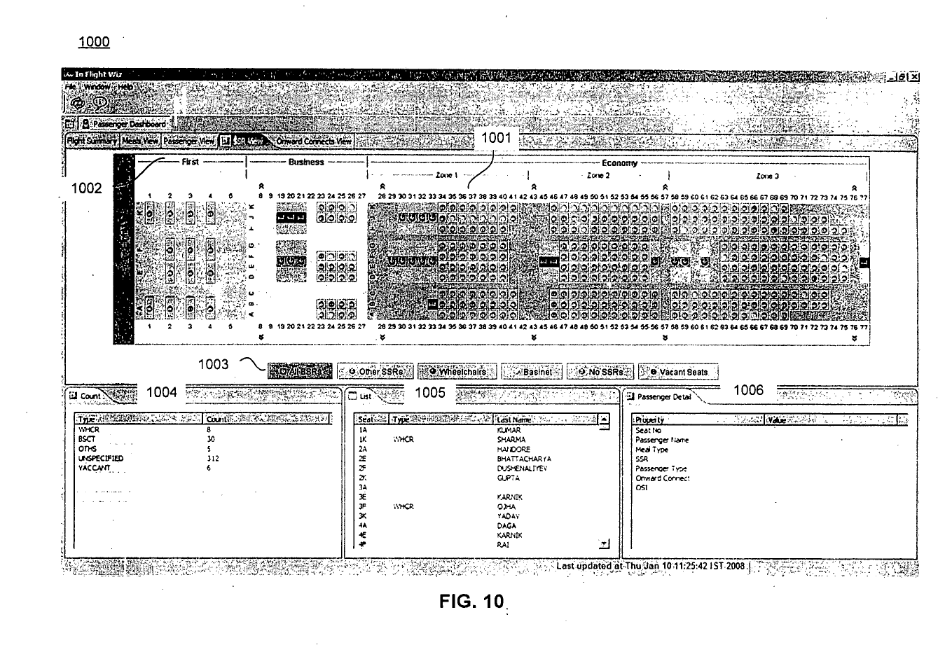

FIG. 10 shows a screen display illustrating an exemplary embodiment of a SSR Report Screen 1000. As illustrated, SSR Report Screen 1000 may include seat map 1001. In some embodiments, seat map 1001 may include seat numbers with demarcations for each class and zones within each class any may include encodings to reflect specific passenger service requests. In some embodiments, seat map 1001 may be selected according to the seating configuration of the aircraft for the trip. Further, in some embodiments, the type of special service requested by passengers occupying the seats may be color coded and may be reflected on each seat. A user may change the display seat map 1001 using clickable buttons 1003. In some embodiments, a user may use clickable buttons 1003 to display a seat map 1001 for an entire aircraft, a particular seating class (i.e. class-wise), a particular zone (i.e. zone-wise), and/or a particular row (i.e. row-wise). In some embodiments, if a particular SSR type is selected 1003, only the selected SSR type may be displayed on the seats.

In some embodiments, SSR Report Screen 1000 may be divided into a plurality of parts. For example, a first part 1004 may display counts of the SSR types of the portion of the seat map 1001 displayed. A second part 1005 may list the seat number, passenger names and/or SSR type which may be based on the type of SSR and portion of the seat map selected. In some embodiments, each seat in seat map 1001 may be clickable or selected from a displayed seating list. Upon clicking or selecting a particular seat, detailed SSR information on the passenger occupying the seat may be displayed in a third part 1006.

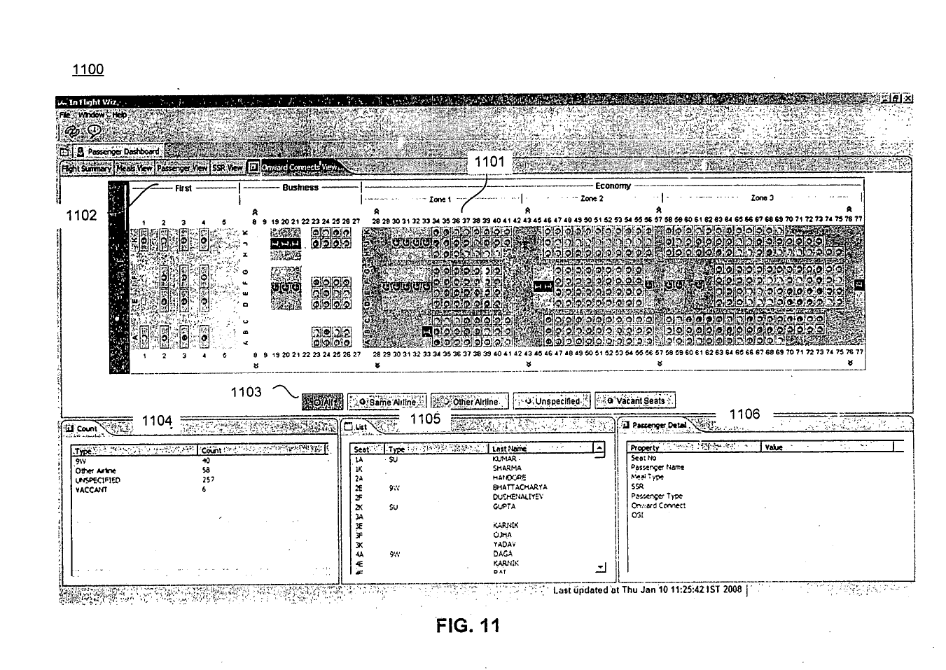

FIG. 11 shows a screen display illustrating an exemplary embodiment of an Onward Connection Report Screen 1100. As illustrated, Onward Connection Report Screen 1100 may include seat map 1101. In some embodiments, seat map 1101 may include seat numbers with demarcations for each class and zones within each class and may include encodings to reflect passengers having different types of onward connections. In some embodiments, seat map 1101 may be selected according to the seating configuration of the aircraft for the trip. Further, in some embodiments, the type of onward connection for passengers occupying the seats may be color coded and may be reflected on each seat. A user may change the display seat map 1101 using clickable buttons 1103. In some embodiments, a user may use clickable buttons 1103 to display a seat map 1101 for an entire aircraft, a particular seating class (i.e. class-wise), a particular zone (i.e. zone-wise), and/or a particular row (i.e. row-wise). In some embodiments, if a particular onward connection type is selected 1103, only the selected onward connection type may be displayed on the seats.

In some embodiments, Onward Connection Report Screen 1100 may be divided into a plurality of parts. For example, a first part 1104 may display counts of the onward connection types of the portion of the seat map 1101 displayed. A second part 1105 may list the seat number, passenger names and/or onward connection type which may be based on the type of onward connection and portion of the seat map selected. In some embodiments, each seat in seat map 1101 may be clickable or selected from a displayed seating list. Upon clicking or selecting a particular seat, detailed onward connection information of the passenger occupying the seat may be displayed in a third part 1106.

The systems and methods disclosed herein are not inherently related to any particular computer or other apparatus, and may be implemented by a suitable combination of hardware, software, and/or firmware. Software implementations may include one or more computer programs. A computer program is a set of instructions readable and executable by a processor and can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network. Software may also be implemented as a computer program product, i.e., one or more computer programs tangibly embodied on a computer-readable medium, such as a storage device or a propagated signal, for execution by, or to control the operation of, data processing apparatus, e.g., a programmable processor, a computer, or multiple computers. In some embodiments, computer-readable media may include, for example, Read Only Memory (ROM), Programmable Read Only Memory (PROM), Flash Memory, Non-Volatile Random Access Memory (NVRAM), or digital memory cards such as secure digital (SD) memory cards, Compact Flash™, Smart Media™, Memory Stick™, and the like. In certain embodiments, as previously discussed, portions of a program to implement the systems, methods, and structures disclosed may be delivered over a network.

Other embodiments will be apparent to those skilled in the art from consideration of the specification and practice of the embodiments disclosed herein. It is intended that the specification and examples be considered as exemplary only, with a true scope and spirit of the invention being indicated by the following claims.

1. A computer-implemented method for delivering trip information to a commercial carrier vehicle, wherein the trip information includes at least one of passenger, travel and vehicle information, the method comprising:
electronically compiling the trip information;
processing the trip information;
electronically distributing the trip information to a computing device located on-board the commercial carrier, in response to a triggering event; and
displaying the trip information.

2. The method of claim 1, wherein passenger information further comprises seat-specific passenger occupancy information, passenger profile information, passenger request information, passenger meal preference information, passenger value information, passenger travel information, and infant information.

3. The method of claim 1, wherein vehicle information further comprises individual seat occupancy information by seat, the seat occupancy information being organized by row, class, and zone.

4. The method of claim 1, wherein electronically distributing the trip information to a computing device located on-board the commercial carrier further comprises:
transmitting the trip information from a host system to a processing system; and
updating stored trip information on the processing system using the transmitted trip information; and
transmitting the updated trip information to the computing device.

5. The method of claim 1, wherein displaying the trip information further comprises
displaying an initial screen on a display device prior to electronically distributing the trip information, the initial screen comprising general vehicle seat layout information.

6. The method of claim 1, wherein the trip information is displayed on a display coupled to the computing device located on-board the commercial carrier.

7. The method of claim 6, wherein the displayed trip information is dynamically updated to reflect any changes affecting the displayed trip information.

8. The method of claim 1, wherein the triggering event is an electronic request from a user.

9. The method of claim 2, wherein the seat specific passenger occupancy information may be selected based on specific user criteria.

10. A computer-readable medium that stores instructions, which when executed by a processor perform a method for delivering trip information to a commercial carrier vehicle, wherein the trip information includes at least one of passenger, travel and vehicle information, the method comprising:
electronically compiling the trip information;
processing the trip information;
electronically distributing the trip information to a computing device located on-board the commercial carrier, in response to a triggering event; and
displaying the trip information.

11. The computer-readable medium of claim 10, wherein electronically distributing the trip information to a computing device located on-board the commercial carrier further comprises:
transmitting the trip information from a host system to a processing system; and
updating stored trip information on the processing system with the transmitted trip information; and
transmitting the updated trip information to the computing device.

12. The computer-readable medium of claim 10, wherein the triggering event is an electronic request from a user.

13. The computer-readable medium of claim 10, wherein passenger information further comprises seat-specific passenger occupancy information, passenger profile information, passenger request information, passenger meal preference information, passenger value information, passenger travel information, and infant information.

14. The computer-readable medium of claim 10, wherein vehicle information further comprises individual seat occupancy information by seat, the seat occupancy information being organized by row, class, and zone.

15. The computer-readable medium of claim 10, wherein displaying the trip information further comprises displaying an initial screen on a display device prior to electronically distributing the trip information, the initial screen comprising general vehicle seat layout information.

16. The computer-readable medium of claim 10, wherein the trip information is displayed on a display coupled to the computing device located on-board the commercial carrier.

17. The computer-readable medium of claim 16, wherein the displayed trip information is dynamically updated to reflect any changes affecting the displayed trip information.

18. The computer-readable medium of claim 13, wherein the seat specific passenger occupancy information may be selected based on specific user criteria.
